(19) United States
(12) Patent Application Publication
(10) Pub. No.: US 2022/0196921 A1
(43) Pub. Date: Jun. 23, 2022

(54) METHOD AND APPARATUS FOR BLOCKING THE TRANSMISSION OF CLASSIFIED DATA OVER OPTICAL FIBER

(71) Applicant: Panduit Corp., Tinley Park, IL (US)

(72) Inventors: Richard J. Pimpinella, Frankfort, IL (US); Bulent Kose, Burr Ridge, IL (US); Jose M. Castro, Naperville, IL (US)

(73) Assignee: Panduit Corp., Tinley Park, IL (US)

(21) Appl. No.: 17/553,897

(22) Filed: Dec. 17, 2021

Related U.S. Application Data
(60) Provisional application No. 63/126,561, filed on Dec. 17, 2020.

(51) Int. Cl. G02B 6/38

(52) U.S. Cl. CPC G02B 6/3825; G02B 6/3897

(57) ABSTRACT

A system for the prevention of the transmission of classified data has a front panel containing a plurality of adapters, a rear panel containing a plurality of adapters, and at least one opto-isolator contained within the enclosure. The opto-isolator is connected via an optical fiber to a connector inserted into an adapter in the rear panel and also connected via a second optical fiber to a connecter inserted into one of the plurality of adapters in the front panel.

### CROSS REFERENCE TO RELATED APPLICATION(S)

This application claims benefit to U.S. Provisional Patent Application No. 63/126,561, filed on Dec. 17, 2020, the entirety of which is hereby incorporated by reference herein.

### FIELD OF INVENTION

The present invention relates generally to optical fiber communications and more specifically to a method and apparatus for preventing unauthorized data from being transmitted to hackers or unsecured networks.

### BACKGROUND

The security of classified data communication in critically sensitive applications such as military intelligence, surveillance and reconnaissance is of utmost importance. Network operators make every effort to prevent unauthorized access to data. However, network switching equipment can be tampered with to re-transmit data to a breached unsecured switch port. In these special applications, to reduce latency real-time data streams are decrypted and transmitted in one direction only over optical fibers at high-speeds to a secure work station for local analysis. In this disclosure we describe a method for blocking optical signals from being re-directed and transmitted from these secure network equipment to unauthorized destinations. The method utilizes opto-isolators to block and prevent re-transmitted optical signals from transmitted to unauthorized operators.

### SUMMARY

A system for the prevention of the transmission of classified data has a front panel containing a plurality of adapters, a rear panel containing a plurality of adapters, and at least one opto-isolator contained within the enclosure. The opto-isolator is connected via an optical fiber to a connector inserted into an adapter in the rear panel and also connected via a second optical fiber to a connecter inserted into one of the plurality of adapters in the front panel.

### BRIEF DESCRIPTION OF THE FIGURES

FIG. 1 is a schematic view of an opto-isolator to be used in the present invention.

FIG. 2 shows a system for the prevention of the transmission of classified data.

FIG. 3 describes the optical signal path according to one embodiment of the present invention.

FIG. 4 shows the optical path when an optical signal carrying secure data is transmitted from a port to an output optical fiber.

FIG. 5 illustrates the front panel of a rack mounted enclosure for use in a system for blocking the transmittion of classified data.

FIG. 6 is a top view of the interior of the enclosure of FIG. 5.

### DETAILED DESCRIPTION OF THE INVENTION

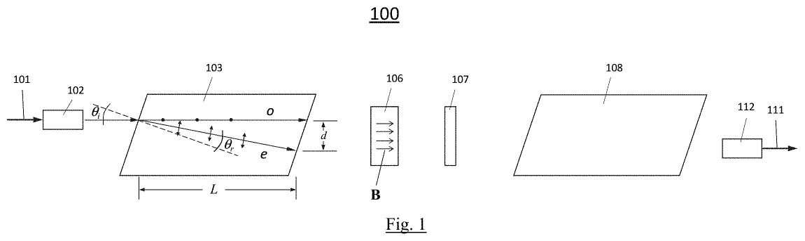

An opto-isolator is the optical equivalent to a diode used in electronics, where current can only flow in one direction. An opto-isolator for use in an optical fiber system, can be constructed using the optical components shown in FIG. 1. In this embodiment, the device includes collimating lenses 102 and 112, optical Beam Displacers 103 and 108, a Faraday Rotator 106, and a Half-wave Plat 107.

A beam displacer is an anisotropic medium that splits an unpolarized beam of light into two orthogonally polarizations. The two polarizations undergo a double refraction, where they separate by an angle θᵣ into two independent polarized rays. The ordinary (o) ray has its polarization aligned perpendicular to the plane of incidence. The ordinary ray is transmitted directly through the beam displacer crystal. The extra-ordinary (e) ray has a polarization parallel to the plane of incidence and is refracted and displaced a distance d, depending on the angle of refraction a, and the path length L through the crystal.

The most widely used materials for beam displacers are Yttrium Vanadate (YVO4) crystal, Alpha Barium Borate (α-BBO) crystal, Calcite crystal, Terbium Gallium Garnet, and Rutile crystal. Among the five materials, YVO4 crystal is the most popular material due to the thermal and mechanical properties, and large birefringence.

A Faraday Rotator consists of an optical material in a magnetic B field. One polarization of the input light is in ferromagnetic resonance with the material which causes its phase velocity to be higher than that of the orthogonal polarization. This causes the polarization of light to rotate as it propagates through the material. For light traveling in the direction of the B field, the polarization is rotated counter-clockwise (CCW) following the Left-hand rule (left hand thumb points in direction of field, fingers point in direction of rotation). Light propagating in the opposite direction rotates in the opposite direction i.e., clockwise (CW) relative to the direction of the B-field, following the Right-hand rule.

Waveplates are constructed out of a birefringent material (such as quartz or mica, or even plastic), for which the index of refraction is different for linearly polarized light along one or the other of two certain perpendicular crystal axes. The crystal is cut into a plate with the orientation of the cut chosen so that the optic axis of the crystal is parallel to the surfaces of the plate. This results in two axes in the plane of the cut: the ordinary axis, with index of refraction nₒ, and the extraordinary axis, with index of refraction nₑ. The ordinary axis is perpendicular to the optic axis. The extraordinary axis is parallel to the optic axis. For a light wave normally incident upon the plate, the polarization component along the ordinary axis travels through the crystal with a speed vₒ=c/nₒ, while the polarization component along the extraordinary axis travels with a speed vₑ=c/nₑ. This leads to a phase difference between the two components as they exit the crystal. When nₑ<nₒ, as in calcite, the extraordinary axis is called the fast axis and the ordinary axis is called the slow axis. For nₑ>nₒ the situation is reversed. Depending on the thickness of the crystal, light with polarization components along both axes will emerge in a different polarization state. The waveplate is characterized by the amount of relative phase, Γ, that it imparts on the two components, which is related to the birefringence Δn and the thickness L of the crystal given,

$$Γ = \frac{2 π Δ n L}{{λ}_{0}} ,$$

where, λ₀ is the wavelength of the light in vacuum. For the Half-wave plate, the relationship between L, Δn, and λ₀ is chosen so that the phase shift between polarization components is Γ=π. As a result, the half-wave plate 207 rotates the polarizations 45° CCW independent of direction the wave propagates through the plate.

The collimating lenses 102 and 112 are used to couple the output and input beams of optical fibers 101 and 111, to the beam displacers 103 and 108 respectively.

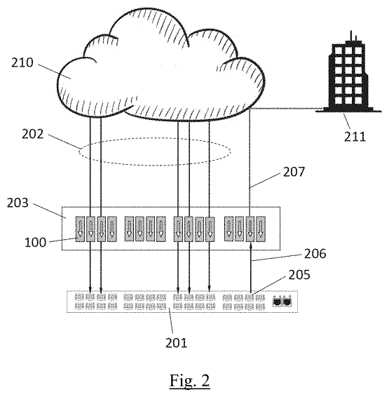

Disclosed is a method and apparatus for preventing secure data from being transmitted to unauthorized destinations. In a network utilizing the proposed method and apparatus, as shown in FIG. 2, data originating in the cloud 210 is transmitted over optical fiber channel links 202 to a network switch 201 via apparatus 203. Apparatus 203 contains one or more opto-isolators 100. According to the present invention, each optical fiber is connected to its destination, in this case switch 201, via an opto-isolator 100.

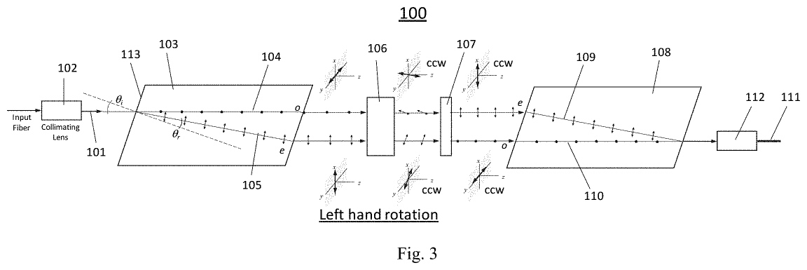

In FIG. 3 we describe the optical signal path according to one embodiment of the present invention. Optical signal 101 originating in the cloud is connected to opto-isolator 100 via collimating lens 102. The signal emanating from collimating lens 102 falls incident on beam displacer 103. In this device, the optical beam splits into two orthogonally polarized beams 104 and 105. The ordinary beam 104 passes straight through beam displacer 103, whereas the extra-ordinary beam 105, is refracted an angle θᵣ relative to the normal to the beam displacer surface 113. Polarized beams 104 and 105 emerge from 103 and pass through Faraday Rotator 106, where the polarization of the two beams are rotated 45° CCW. Next, the beams pass through a half-wave plate 107, where beams 104 and 105 are rotated an additional 45° CCW. At this point, the polarizations of beams 104 and 105 have been rotated 90° and have the opposite polarizations from when they entered 103. As the beams enter the second beam displacer 108, the ordinary beam 110 passes straight through beam displacer 108, whereas the extra-ordinary beam 109 is refracted by the same angle θᵣ. After passing through beam displacer 108, the beams recombine and collected by collimating lens 112, and connected a transceiver via optical fiber 111.

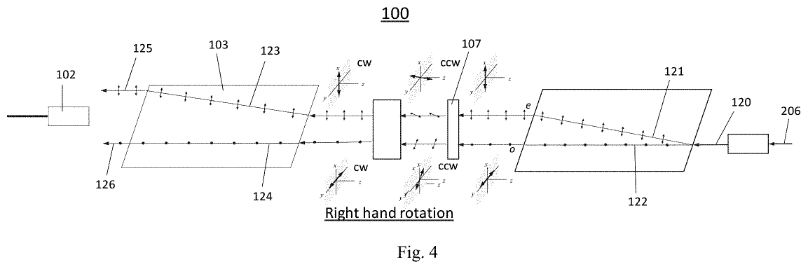

In FIG. 4, we describe the optical path when a an optical signal carrying secure data is transmitted from port 205 to output optical fiber 206. The breached optical signal must be blocked by an opto-isolator 100. In this scenario, the signal is first split into two polarizations, the ordinary beam 122 and the extra-ordinary beam 121. As the beams propagate through the optical components in the reverse direction, the polarizations do not undergo the same rotations as they did in the forward direction. In this case, the half-wave plate performs the same CCW rotation as it did in the forward direction, however, in the Faraday Rotator, the signal is propagating in the opposite direction to the magnetic B field. As a result, the two polarized beams 121 and 122 are rotated CW, nullifying the rotation caused by the half-wave plate 107. As a result, the ordinary beam 124 pass straight through the beam displacer 103 and the extra-ordinary beam 123 is refracted, hence, the two beams do not converge into collimating lens 102 and the signals 125 and 125 are absorbed and scattered within the device.

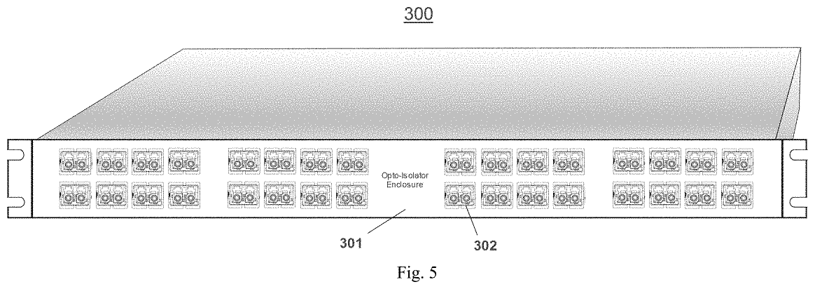

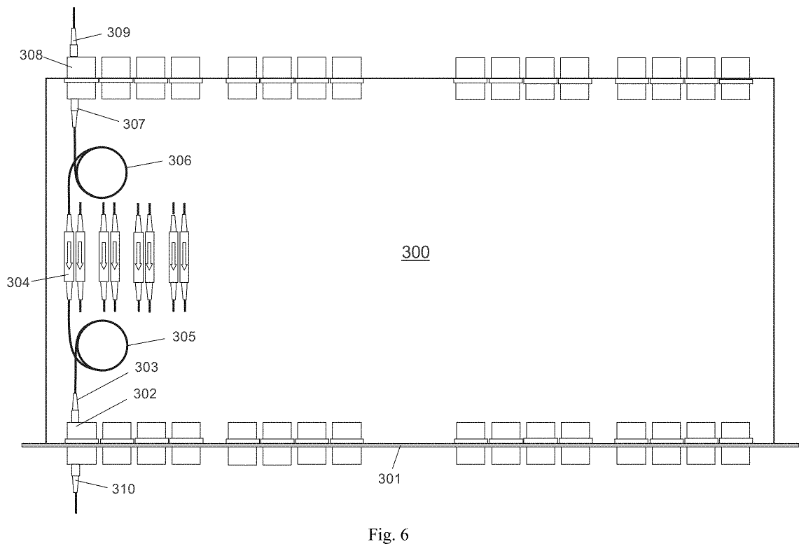

Although the opto-isolators can be installed in many types of enclosures, it is advantageous to manage the devices in an enclosure designed for rack mounting. In FIG. 5, we illustrate the front panel 301 of a rack mounted enclosure 300 having 32 optical duplex connector ports 302. Following industry Standards and proper structured cabling practices, optical connectivity for communication equipment utilize duplex patch cords as equipment cords. In FIG. 6 we show an exemplary configuration for one opto-isolator 304. An optical fiber carrying secure data 309 is connected (in this case) to duplex fiber adapter 308 located in the rear of enclosure 300. The optical signal is routed to a duplex connector adapter 302 located on front panel via opto-isolator 304. Optical fiber 310 completes the link carrying the communications data to the secure equipment.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A system for the prevention of the transmission of classified data comprising:
a front panel containing a plurality of adapters;
a rear panel containing a plurality of adapters;
at least one opto-isolator contained within the enclosure, the opto-isolator connected via an optical fiber to a connector inserted into an adapter in the rear panel and connected via a second optical fiber to a connecter inserted into one of the plurality of adapters in the front panel.
